(19) United States
(12) Patent Application Publication
(10) Pub. No.: US 2012/0156965 A1
(43) Pub. Date: Jun. 21, 2012

(54) METHOD AND APPARATUS FOR THE PRODUCTION OF EXTRAORAL DENTAL PROSTHESES

(76) Inventor: Jens WEYRAUCH, Elsenfeld (DE)

(21) Appl. No.: 13/329,120

(22) Filed: Dec. 16, 2011

(30) Foreign Application Priority Data
Dec. 20, 2010 (EP) 10195969.0

(51) Int. Cl. A61C 13/007; B24B 19/00; B24B 1/00; A61C 13/38; B23P 13/00

(52) U.S. Cl. 451/5; 451/57; 29/896.1; 451/65; 451/69

(57) ABSTRACT

The disclosure relates to a method and apparatus for the extraoral production of a tooth replacement part, whereby the method comprises providing a base body (300); rotary grinding of the base body; and grinding of the base body. Further, a milling step is possible. The presented method significantly reduces the production times, because it minimizes the time required for milling.

### BACKGROUND OF THE INVENTION

1. Field of the Invention

The present disclosure pertains to a method and apparatus for the production of a dental prosthesis. Especially, the disclosure pertains to a method for the production of a dental prosthesis made extraorally by machining a base body, especially, a rod-shaped base body.

2. Description of the Related Art

Essentially, in restorative dentistry there exist two methods for the restoration of teeth with hard matter defects that were, for example, caused by caries. The defects are either treated directly at the tooth with plastic filling material, whereby the defective tooth material is removed by drilling and subsequently filled with a fluid or viscous filling material. After hardening and post-processing of the filling material, no further therapeutic measure is required.

In contrast, the present disclosure pertains to extraorally made dental prostheses. These include small ceramic abutments, inlays, onlays, veneers and crowns. These do not include fastening means that are designed for anchorage into the bone like, for example, implants. Bridges, serve as replacement for entire teeth, their abutting teeth are prepared as for the up take of crowns. For the extraorally made therapy mediums, production of the therapy mediums takes place outside of the oral cavity, whereby information that is necessary for the production is collected inside the oral cavity with conventional casting compounds or measured intraorally with scanners. The therapy mediums are produced based on these specifications that are, if necessary, supplemented by further information from the dentist. The dentist affixes the completed therapy mediums on the prepared teeth such as with a special cement like zinc-phosphate-cement.

In the prior art, the dental prosthesis is, for example, poured. For this purpose, the cast taken by the dentist or a mold based on this form is effused with liquid material such as, for example, gold. Further specifications, for example, of the desired occlusal surface structure are regularly given from the dentist in charge to the dental technician responsible for the production of tooth replacement parts. Numerous materials for the tooth replacement parts are metals, ceramics or composites. They regularly have a melting point that lies over 1,000° C.

The present application pertains to tooth replacement parts that are produced by mechanical machining processes. Thereby, machining shall include all mechanical working processes in which the material is brought into the desired shape by removing excess material in the form of chips.

In the prior art, the production therefore occurs from milling of discs with suitable height. This is illustrated in FIG. 1. With the aid of mills, a number of ca. 10-30 tooth replacement parts are milled from a disc 100 of, e.g., 10 mm height and a diameter of, e.g., 10 cm. FIG. 1 shows such a disc before milling. In view of the parts to be milled, preferably, a meaningful disc layout is chosen, whereupon in the milling step then, the individual tooth replacement parts are milled. As illustrated in FIG. 2 there are, for example, smaller tooth replacement parts that for this reason also lead to smaller burr holes 210, as well as larger tooth replacement parts since they concern, for example, bridges connecting several teeth, which for this reason also lead to larger burr holes 220 or 230. Thereby, the goal is to position the millings in such a way that the amount of material 240 remaining in the discs is as low as possible.

During milling, material is removed from the disc with the aid of a rotating precision cutting tool with a pointed milling head until the tooth replacement part is finally shaped. In addition, sometimes at least two anchors for the connection between the tooth replacement parts and the disc are left behind, which represent a thin attachment of the tooth replacement parts to the disc and, thus, ensure that the tooth replacement part remains in the disc. In such a way, for example, a disc is delivered as a whole, with milled out tooth replacement parts still fixed in the disc over the anchors, to a dental laboratory or a dentist, who then only—also with a milling tool—needs to remove the tooth replacement parts from the disc and needs to fit them into the patient.

However, this method is time consuming and therefore costly. Typical time expenditure per tooth replacement part is about 15 minutes. The optimal utilization of material is achieved only rarely and, yet, much time is spent on positioning the burr holes in such a way that a minimum of surplus material remains in the discs. In addition, some tooth replacement parts are to be structured such that not all places are easily accessible from above or below the disc. Eventually, this leads to relatively large burr holes, whereby a not inconsiderable number of these burr holes are only milled to allow access of the milling machine to underlying parts. Therewith, not only a lot of material is consumed but associated therewith is also great time consumption.

### SUMMARY OF THE INVENTION

The present invention generally Therefore, it is desired that the present disclosure overcomes the aforementioned disadvantages, at least, in part. For this purpose, according to one aspect a method for extraoral production of a tooth replacement part is presented that comprises providing a base body, the rotary grinding, and the grinding of the base body.

The presented method allows for a particularly time-efficient method of producing tooth replacement parts. The time, of up to 15 min, needed in the prior art can often be halved, since high material erosion is achieved in short time by the combination of rotary grinding and grinding. In addition, according to the choice of base body, the amount of material used per tooth replacement part may also be reduced. This is especially true for the rods described in more detail, which are used herein interchangeably for “bars”.

According to another aspect, an apparatus for producing an extraoral tooth replacement part is provided, whereby the apparatus comprises an installation for rotary grinding as well as an installation for grinding.

Additional advantageous embodiments, further developments and details of the disclosure will be apparent from the subordinate claims, the description as well as the figures.

The tooth replacement part to be produced is typically a tooth replacement part to be manufactured individually, in particular, a single crown and/or a multi-unit bridge. In particular, the tooth replacement part to be produced has no shape that is identical for multiple tooth replacement parts. Regularly, the tooth replacement part to be produced is further not an installation for anchoring into the jaw bone such as, for example, an implant.

The term “rotary grinding” is used herein synonymously with “turning”. According to DIN 8580 it refers to the main group separation and the group chipping with geometrically defined cutting edge shape. According to DIN 8589, turning is “chipping with a closed and generally circular cutting motion and any feed motion in a plane that is vertical to the cutting direction. The rotary axis of the cutting motion retains its position to the workpiece regardless of the feed motion.” The rotary grinding set out herein comprises, in particular, the rotation of the base body from which the tooth replacement parts are produced.

Rotary grinding may include face turning, cut-off turning, straight turning, profile turning and/or form turning. Embodiments of the disclosure described herein include, in particular, form turning, accordingly may include computer-controlled structures also such as, for example, grooves and notches that are formed in the tooth replacement part. Thereby, it should be noted that the shaping by the rotary grinding typically occurs rotationally symmetrically.

Grinding is a chipping manufacturing process for machining surfaces with abrasives. According to DIN 8580 it belongs to the main group of separation, to the group of kinds of machining with a geometrically undefined cutting edge. In contrast to rotary grinding, during grinding the cutting edge is set into a typically fast movement as opposed to the base body, whereby the base body is typically at rest.

However, thereby it is also possible that the base body rotates at a typically low rotation speed like, for example, with a rotation speed between 5 and 500 revolutions per minute. Through this combination, with suitable control of the cutting edge for grinding, for example, the base body can be brought into an oval shape.

According to the embodiments described herein, the cutting edge for grinding is rotationally symmetrical and brought into a rotational movement. The principles are, in particular, rotary grinding (longitudinal rotary grinding or perpendicular rotary grinding). According to embodiments, the cutting edge for grinding is a round body with a diameter of at least 2 cm, typically of at least 3 cm. The cutting edge for grinding, consisting of adhesive agents and grains, has a typical sieving size between FEPA F220 to FEPA F80.

The rotational speed during turning is typically between 500 and 5,000 revolutions per minute, thus, the base piece rotates at this speed. During grinding the rotational speed of the grinding surface is typically between at least 500 revolutions or at least 2,000 revolutions per minute. This is regularly dependent on the diameter of the grinding disc. So, for example, with a diameter of 15-25 mm, rotational speeds of 2,000 to 30,000 revolutions per minute may occur and with a diameter of 200-300 mm, rotational speeds of 500 to 600 revolutions per minute.

According to the embodiments described herein, the method comprises one or more of the following additional steps:

clamping the base body in a rotary apparatus; and/or

milling of the base body.

Rapid and effectively large material erosion can take place through the rotary grinding. In the case of milling, the comparable time for the same ablation would be a multiple of the time that is needed during rotary grinding. In addition, during rotary grinding the cutting pressure is regularly less than during milling, which is advantageous for the material and the tooth replacement part to be produced. Typically, the amount of material to be grinded off by turning per tooth replacement part to be produced is maximized.

According to embodiments, first a rotary grinding of the base body takes place. The base body is typically rotationally symmetrical and has an axis of rotation (herein termed “axis”); the base body is in particular cylindrical or rod-shaped. Such a bar may have been, for example, produced with the continuous casting process and may have a length of between 0.25 m and 2.0 m.

Grinding typically takes place as the second step. Grinding also permits a high material erosion and little cutting pressure thereby. As opposed to turning, grinding is not limited to a rotationally symmetrical shaping but permits a local erosion of material.

The milling of the base body for producing the tooth replacement part takes place as precision working step. Milling is done locally at the appropriate places, while rotary grinding leads to a rotationally symmetrical structuring of the tooth replacement part. In contrast to turning, the necessary cutting motion for the chip removal during milling is produced by the rotation of the cutting tool with respect to base body that is firmly clamped to the machine table. As opposed to grinding, however, the cutting tools are rotational bodies of smaller size like, for example, of maximally 10 mm, typically maximally 5 mm or maximally 3 mm diameter. The feed motion necessary for the shaping may, depending on the design, be achieved either by moving the machine table or by movement of the milling tool relative to the base body.

The tooth replacement part to be produced must of course be dimensioned such that it is producible from the diameter of the base body. Through the rotary grinding, the base body is reduced to a size that corresponds to the maximum diameter of the tooth replacement part to be produced. Typically, this rotary grinding includes face turning and/or straight turning.

It is further possible that a rotary grinding or grinding follows after the milling. For example, first, rapid and efficient material erosion may occur in a rotary grinding and grinding procedure, whereupon the exact milling of the desired structure takes place. Subsequently thereto, again a rotary grinding may follow, for example, a cut-off turning or a turning near to the cut-off, for instance, to detach the tooth replacement part then produced from the basis body. This detachment by cut-off turning also goes fast and is superior to the milling. According to further embodiments, a multiple succession of turning and milling takes place per tooth replacement part.

Per tooth replacement part to be produced, according to an exemplary embodiment, the base body is initially, for instance, chipped to the maximum diameter of the tooth replacement part to be produced by straight turning or face turning. Further material erosion occurs by grinding. For fine structuring, finally milling can occur in a further step.

The method can further comprise attaching the base body on a rotary plate. The base body can, for example, be clamped in a clamping installation that is fixed to the rotary plate. The rotary plate in the meaning understood herein is a base that is configured to rotate itself and the base body with a possibly predeterminable speed. In addition, the rotary plate typically may be fixed, for example, to perform grinding and/or milling on a body in fixed position.

According to a typical embodiment the base body is rotationally symmetrical, especially cylindrical. The base body is, for example, a rod and may have a length of at least 10 cm, typically at least 20 cm or at least 50 cm. The longer the rod, the more tooth replacement parts may be produced from the rod. At the same time, the effort of attaching the rod on the rotary plate is reduced.

According to embodiments described herein the base body consists of a cobalt-chromium alloy, especially a chromium-cobalt-molybdenum alloy. Depending on the manufacturer, it contains about 62-66% cobalt, 27-31% chromium, 4-5% molybdenum as well as traces of carbon, silicon, manganese, iron, and/or other components. Particularly preferred is a rod of Keragen®, which was produced in particular by a continuous casting process and is therefore free of cavities and gas bubbles. Keragen® is a cobalt-chromium alloy, which contains no molybdenum. It has proven to be a durable and well-tolerated material. Typical diameters are between 7 mm and 20 mm, especially between 8 mm and 12 mm as in 8 mm, 9.5 mm or 12 mm. They were typically produced by a continuous casting, a glass casting or through a sintered HIP (Hot Isostatic Pressuring) process. They, thereby, have a high degree of homogeneity and are free or nearly free of cavities and gas bubbles.

Due to the high melting temperatures of at least 1,200° C., the tooth replacement parts made of a cobalt-chromium alloy are often produced through machining by chip removal. The cobalt-chromium alloy has proven itself in dental surgery, since it has great hardness, is completely corrosion resistant and does not lead to any discoloration in the mouth due to influences of saliva or food. The rate of allergic reactions in patients is low, and its compatibility is high. In some health systems it is further advantageous that the costs for dentures of these alloys is covered by insurance, while the costs of biomaterials such as gold, platinum or titanium are not covered.

According to embodiments, the method is carried out partly or entirely by a computer. Thereby, a computer controls the turning and/or grinding according to the disclosure and possibly also further processes such as, for example, milling. In particular, the computer can be connected to a network such as, for example, the World Wide Web, over which it receives data on how the desired tooth replacement parts are supposed to look. For example, such data may be transferred to the computer in the form of an STL-file. The computer may have an input unit such as, e.g., a mouse and/or a keyboard, a displaying unit such as, e.g., a monitor, a processing unit such as, e.g., a CPU (Central Processing Unit) and a storage unit such as, e.g., a permanent memory, for example, a hard drive and/or a volatile memory, for example a RAM (Random Access Memory). The computer controls the rotary grinding machine, which according to the embodiment described herein is combinable with all the other herein described embodiments that have at least one rotary chisel, one rotary plate and securing means for the rods to be clamped. The computer can also control the milling tool, with the aid of which, final works to the tooth replacement part are being made.

Typically, the method according to the disclosure takes place partially or fully automatically. Thereby, the required working time of a processor, for example, a dental technician may be reduced and thereby costs are saved.

According to embodiments, the method also comprises cutting-off the tooth replacement parts from the base body. Cutting-off typically takes place after completion of the desired structure on the tooth replacement part.

Typically, each tooth replacement part to be produced is individually manufactured. Therefore, the method presented is not concerned with mass production of a structured work piece of dentistry that is always the same, but with a tooth replacement part formed from individual specifications. Due to this reason, amongst others, combining rotary grinding and grinding for the production of tooth replacement parts was not considered in the state of the art.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a base plate from the state of the art for the production of tooth replacement parts before processing.

FIG. 2 shows a base plate from the state of the art for the production of tooth replacement parts after the tooth replacement part was milled out.

FIG. 3 shows examples of possible embodiments of a base body for use in the method according to the disclosure.

FIGS. 4 and 5 show schematically possible embodiments of an apparatus according to the disclosure.

FIGS. 5-8 show schematically a possible embodiment of a virtual embedding in accordance with an optional step according to the disclosure.

FIG. 9 illustrates an example of material erosion using turning, grinding and milling according to an embodiment.

FIG. 10 shows possible embodiments of the method according to the disclosure.

FIG. 11 shows schematically a possible embodiment in accordance with an apparatus according to the disclosure.

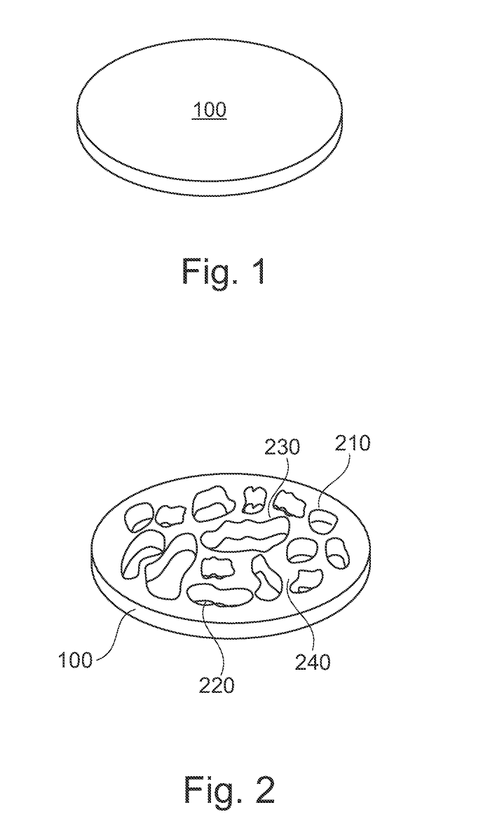

### DETAILED DESCRIPTION

In the following figures the same reference number indicates the same element.

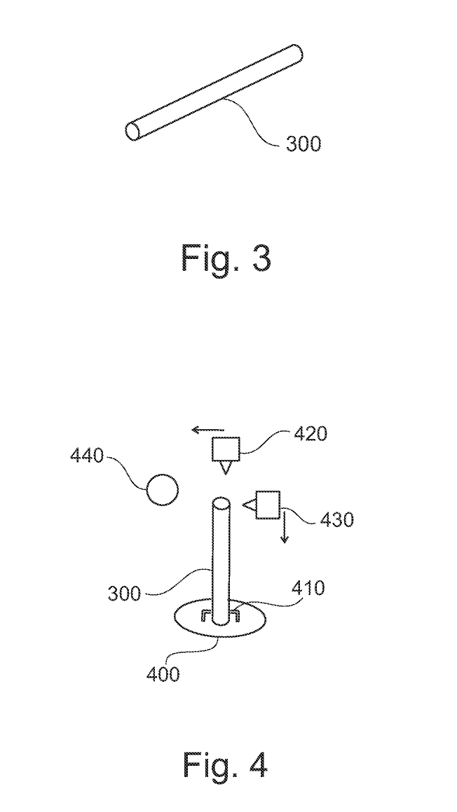

FIG. 3 shows exemplarily one possible embodiment of a base body for use in the method according to the disclosure. The rod-shaped base body, which, for example, consists of a chromium-cobalt alloy, according to the disclosure is used to produce a tooth replacement part by means of turning. A typical length of the rod-shaped base body is up to 2 m.

Thereby, the method functions according to the embodiment illustrated in FIG. 4 as follows: the base body 300 is anchored by means of, for example, a clamping device 410 on the rotary plate 400. The rotary plate can be powered by a motor. The rotation speed should be matched with the ideal cutting speed.

By way of example and schematically, the grinding chisel 420 and 430 are shown in the embodiment of FIG. 4. According to another embodiment only one grinding chisel is used, which is optionally positionally and directionally adjustable. The representation of FIG. 4 can be regarded as a representation of two differently oriented grinding chisels, or merely as representation of one grinding chisel at two different points in time.

According to the embodiments described herein, the method may comprise face turning. This is also indicated in FIG. 4 with the grinding chisel 420. During face turning the grinding chisel is oriented in the axial direction of the base body, whereby the direction of movement of the grinding chisel (“feed direction”) takes place in the radial direction with respect to the axis of the base body. This is indicated by the drawn arrow above the rotary chisel 420.

The method may also comprise straight-turning. This is also indicated in FIG. 4 with the rotary chisel 430. During straight-turning, the grinding chisel is oriented transversely to the axial direction of the base body, that is, in its radial direction, whereby the feed direction occurs in axial direction with respect to the axis of the base body. This is also indicated by an arrow next to the grinding chisel 430.

Especially, in the repeated production of similar morphologies, it is also conceivable that the same profile turning is used. During profile turning a texture is already reproduced in the grinding body, such that not only one contact point between the grinding chisel and the tooth replacement part to be produced exists at one time but possibly a surface of a few mm that it glides over. This also reduces the required production time for a tooth replacement part.

Moreover, the embodiment of FIG. 4 also shows a grinding disc 440. In the case at hand, the axis of the grinding disc is shown perpendicular to the axis of the base body. According to embodiments, the axis of the grinding disc is positioned coaxially to the axis of the base body.

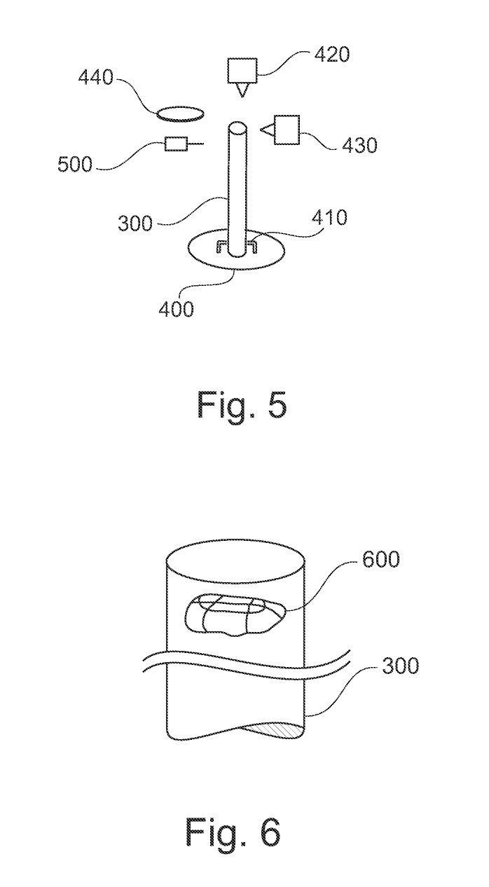

FIG. 5 illustrates further embodiments. In addition to the rotary chisel 420, used for rotary grinding, the arrangement shown also comprises a milling head 500, which is used for milling. As previously described, according to embodiments described herein, a milling process takes place. Additionally, the grinding disc 440 is shown for grinding with coaxial alignment to the base body. Typically, the milling process occurs after the grinding process, which in its turn often takes place after the rotary grinding process.

Typically, the process to which this disclosure relates takes place partially or fully automatically. The following described steps, with reference to FIGS. 6-8, may be undertaken by a supervisor such as a dental technician or they are taken over as software steps by a computer.

According to embodiments all tooth replacement parts to be produced are initially divided into virtual groups, whereby for their production all members of a group need a similar maximum rod diameter. Thus, for example, there may be the group of small tooth replacement parts, which may be produced with a rod diameter of ca. 8 mm, the group of medium-sized tooth replacement parts that may be produced with a rod diameter of ca. 9.5 mm, and the group of large tooth replacement parts, those that may be produced with a rod diameter of ca. 12 mm. Typical numbers of different groups are 2, 3, 4, or even 5. This also significantly depends on the number of tooth replacement parts to be produced within a specified time. The purpose of this division is to reduce the amount of material to be removed as much as possible.

With exemplary reference to FIG. 6, the tooth replacement part to be produced, which is designated with 600 in the Figures, is placed virtually in the base body. Thereby, according to embodiments that may be combined with other embodiments described herein, the tooth replacement part to be produced is placed into the base body in such a way that the required material input is minimized. In addition, the optimization can be in such a way that as much of the material to be removed as possible is removed with rotary grinding. In cases where there is an additional milling process, the optimization may also be such that as little of the material to be removed is removed with milling.

Another possible optimization in the method to which this disclosure relates to concerns maximizing the number of tooth replacement parts to be produced from one base body. For example, the tooth replacement parts to be produced are placed into the base body in such a way that the height taken up by each is minimized.

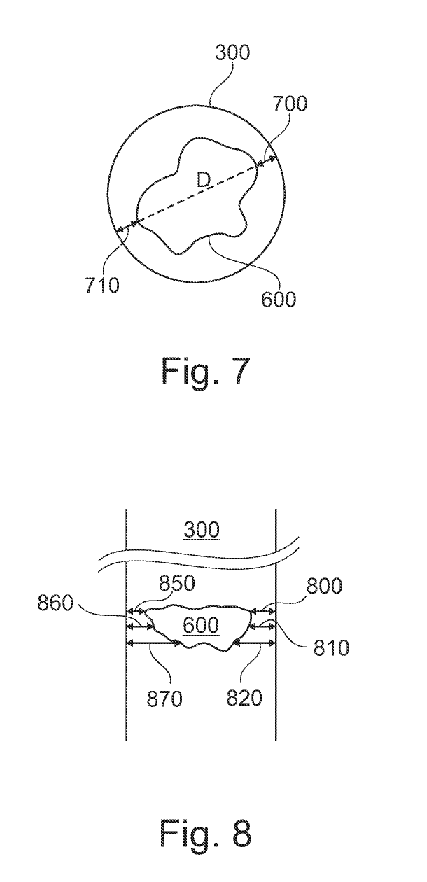

In one embodiment of the method, based on the uploaded data, the tooth replacement part to be produced is placed virtually into the base body. This is set out in a three-dimensional view in FIG. 6. FIG. 7 shows the matching cross section. It is apparent that the tooth replacement part to be produced 600 is positioned into the base body 300 in such a way that the distance 700 and 710 to the edge remains. In a purely two-dimensional optimization, optimizing the amount of material to be removed with turning so that the distances 700 and 710 are of equal size would be favorable, since the smallest distance to the edge decides up to which diameter D the tooth replacement part may be milled by rotary grinding.

According to an embodiment of the present disclosure, a three-dimensional optimization is performed. The base body, for example, is ground to different extents to different axial heights. This is illustrated in FIG. 8, which represents a longitudinal section through the base body along with the virtually fitted tooth replacement part. The schematically illustrated tooth replacement part 600 shall have a larger expansion in the upper area than in the lower down lying area (whereby the term “up” and “down” as well as the following terms “left” and “right” are merely facilitating reference to the figure). By turning, especially, face turning or straight turning, a different diameter of the base body may be removed for different axial heights. Thus, FIG. 8 shows in the upper area a distance 850 to the left edge and a distance 800 to the right edge. Due to the overall optimization, it may be that the distance 800 does not equal the distance 850. At this height, rotary grinding may only occur up to the smaller distance of the distances 800 and 850.

In the embodiment of the tooth replacement part shown in FIG. 8, it is apparent that the turning in lower downlying heights shall not only extend to the smaller distances of 800 and 850 but based on the desired shape a larger material erosion by the quicker and material-friendly rotary grinding should take place. Thus, rotary grinding occurs in the illustrated mid-height up to the smaller distance of the distances 810 and 860, and shown in the lower height, rotary grinding occurs up to the smaller distance of the distances 820 and 870. Generally speaking, this means that the base body according to height, in respective embodiments is milled by rotary grinding up to different diameters. Typically, this is followed by another grinding step, and according to embodiments further material erosions are made by milling.

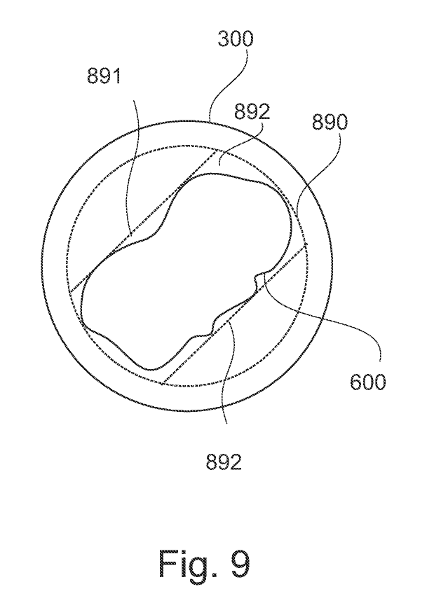

FIG. 9 illustrates the removal of material by different methods. The tooth replacement part 600 is to be produced with the shown cross-section. The material is removed from the base body 300 up to the circle 890, marked with the dashed lines, by means of rotary grinding. Thereby an extensive amount of material is removed in a time efficient manner. The further, large amount of material removed that can not be done using rotational symmetry any longer, now occurs by grinding up to the marked lines 891 on the one side and 892 on the other side. This, for example, can be done by grinding of the stationary base body. It is also possible that at least a part of the material removed through grinding occurs on a rotating base body. For example, an oval shape may be produced by specifically varying the contact pressure of the grinding disc during the slow rotation (hence, e.g., with less than 500 rotations per minute) of the base body.

In the embodiment shown in FIG. 9 the remainder is removed by means of milling. In other embodiments, possibly other portions may be removed by grinding, for example, a large part of the area designated with 892. Finer contours, especially, chamfers and depressions can, however, regularly only be produced with milling.

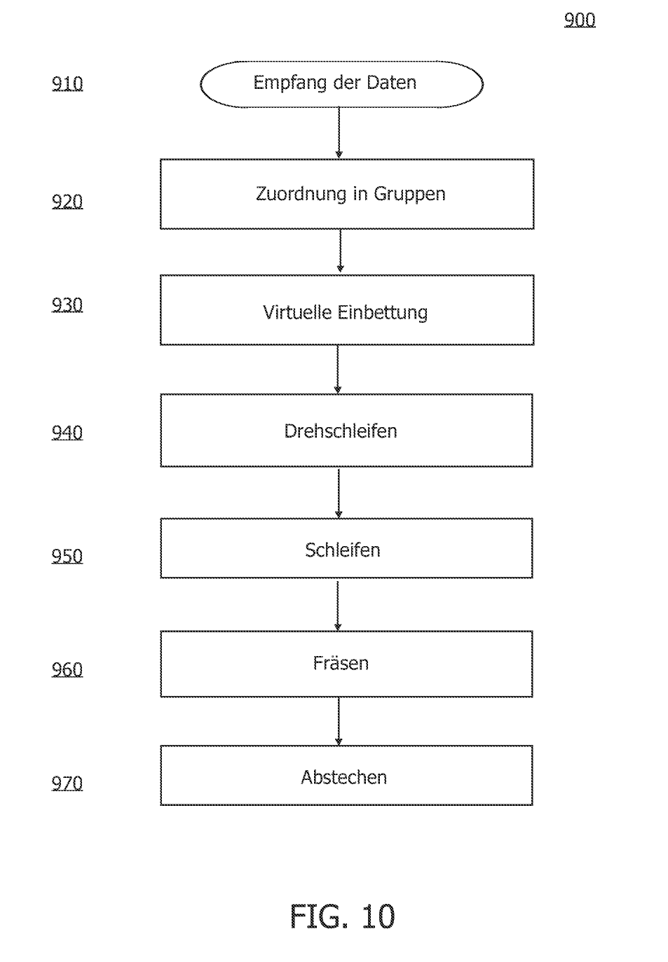

FIG. 10 illustrates a typical procedure according to an embodiment of the method to which this disclosure relates. Thereby, this simply represents one example and shall not be construed as limiting. Some of the individual steps shown may be omitted or be solved alternatively.

The exemplified method 900 begins with receiving the data in block 910. These usually comprise at least one file, like for example an STL-file, normally multiple files on tooth replacement parts to be produced.

According to the received data the tooth replacement parts to be produced are optionally grouped into virtual groups in block 920. As already set out, various groups may be formed that require base bodies of different size to produce them with base rods with diameters of varying size. Typical diameters are around 8 mm, often up to 12.5 mm. For example, a first group of tooth replacement parts to be produced with a maximum diameter of 8 mm may be formed, a second group with tooth replacement parts to be produced with a maximum diameter of 9.5 mm may be formed and a third group with tooth replacement parts to be produced with a diameter of 12 mm may be formed. The optional step of grouping allows for further material optimization.

As next block 930, the tooth replacement parts to be produced are virtually embedded in the chosen base body. This embedding can be done manually or by a computer. Normally, the aforementioned optimization conditions are complied with.

According to the virtual embedding, the tooth replacement part is, finally, produced. According to block 940, in a first step rotational symmetric material erosion is preformed by turning. This can occur for each axial height of the base body up to its own diameter. The standard of this step is to regularly achieve greatest possible material erosion by turning.

According to block 950 the grinding of the base body follows in an additional step. Thereby, the goal is to undertake a large portion of the non-rotationally symmetrical material erosion.

In block 960, follows the milling of further chippings. The milling can take place manually or under computer control. The milling allows precise local structuring.

Basically, for an identical tooth replacement part turning, grinding and milling may alternate or the individual steps may repeat. Furthermore, it is also conceivable to undertake grinding and milling on the form body in parallel.

After completion, to the greatest possible extent of the desired structure of the tooth replacement part, it is detached from the base body. This can occur by cut-off turning or by milling and is shown in FIG. 9 by block 960. It is possible that an additional clamp unit (not shown) grabs the tooth replacement part during cutting-off. The clamp unit that may either be manually or computer controlled, may also be used to directly transport the tooth replacement part to where it is either stored or finally needed for the further processing.

The steps are repeated depending on yet further tooth replacement parts to be produced. For example, the virtual embedding of the next tooth replacement part to be produced may be continued directly with block 930. After producing a tooth replacement part, the base body, typically, is not required to be replaced but may be used for the production of a few, normally, at least 10 tooth replacement parts.

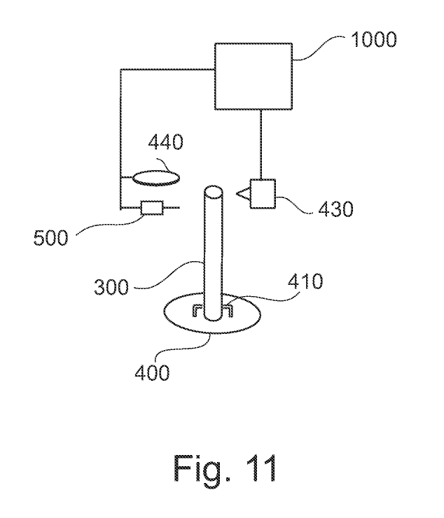

FIG. 11 finally shows an embodiment, whereby, for illustration a computer 1000 is shown. Regularly, the computer serves to control the rotary cutting installation, the rotary chisel 430 shown schematically in FIG. 11, and the grinding installation, the schematically shown grinding disc 440 in FIG. 11. In addition, the computer may also serve to control the milling installation, the milling tool 500 shown in FIG. 11. According to embodiments the computer may also serve the rotary plate shown schematically as 400 in FIG. 11. The computer is typically connected to the internet.

The present method and the set out apparatus are designed for the production of tooth replacement parts. Thereby the material removing devices (rotary chisel, grinding cutter, milling device) must be capable of dealing with materials of the highest hardness (Brinell hardness of up to 400 kg/mm² or according to DIN EN ISO 6506-1 status: 03/2006: 400 HBW 10/3000), especially with chromium-cobalt-alloys. Equally elemental is the suitability of the material removing devices to be capable of producing structures with a precision of 5 μm or even 3 μm.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

While the foregoing is directed to embodiments of the present invention, other and further embodiments of the invention may be devised without departing from the basic scope thereof, and the scope thereof is determined by the claims that follow.

1. Method for the extraoral production of a tooth replacement part, comprising:
providing a base body (300);
rotary grinding of the base body; and
grinding of the base body.

2. Method according to one of the preceding claims, whereby the base body is rotationally symmetric, especially rod shaped.

3. Method according to claim 2, whereby the rod shaped base body has diameter of at least 8 mm, optionally of at least 9.5 mm.

4. Method according to one of the preceding claims, further comprising:
milling of the base body.

5. Method according to one of the preceding claims, whereby the base body consists of a chromium-cobalt-alloy.

6. Method according to one of the preceding claims, whereby the method is executed according to the following succession:
rotary grinding of the base body;
grinding of the base body; and
optional milling of the base body.

7. Method according to one of the preceding claims, further comprising one or more of the following operations:
receiving of data for the production of the tooth replacement part;
clamping of the base body on a rotary plate; and
turning off of the finished tooth replacement part.

8. Method according to one of the preceding claims, whereby the rotary grinding, the grinding, and the optional milling occur with a precision of 5 μm, optionally of 3 μm.

9. Method according to one of the preceding claims, whereby the grinding of the base body is undertaken whilst the base body rotates.

10. Computer program for carrying out on a data processing installation, which comprises executable commands for the method according to one of the preceding claims.

11. Apparatus for the extraoral production of a tooth replacement part from a base body (300), comprising:
an installation for rotary grinding (420, 430) of the base body (300); and
an installation for grinding (440) of the base body.

12. Apparatus according to claim 11, whereby the base body is rotationally symmetric, especially rod shaped, and has a diameter of at least 8 mm, optionally 9.5 mm, and optionally consists of a chromium-cobalt-alloy.

13. Apparatus according to claims 11-12, further comprising:
an installation for milling (500) of the base body.

14. Apparatus according to one of the claims 12-13, further comprising one or more of the following elements:
a computer (1000) for receiving data of the tooth replacement part to be produced and/or controlling at least one installation for rotary grinding, the installation for grinding, and the installation for milling of the base body; and
a clamping installation (410) for fixing the base body on a rotary plate.

15. Apparatus according to one of the claims 11-14, whereby the installation for rotary grinding, the installation for grinding, and/or the installation for milling are set up for chipping with a precision of at least 5 μm, optionally 3 μm.
